(19) United States
(12) Patent Application Publication
(10) Pub. No.: US 2026/0336582 A1
(43) Pub. Date: Oct. 29, 2026

(54) METHOD FOR CONTROLLING A HYDRAULIC BRAKING SYSTEM AND HYDRAULIC BRAKING SYSTEM

(71) Applicant: ZF Active Safety GmbH, Koblenz (DE)

(72) Inventors: Christoph PROBST, Bendorf (DE); Daniel SUTEDJA, Koblenz (DE)

(21) Appl. No.: 19/550,734

(22) Filed: Feb. 26, 2026

(30) Foreign Application Priority Data
Mar. 5, 2025 (DE) 102025108418.1
Sep. 23, 2025 (DE) 102025138491.6

(51) Int. Cl. B60T 8/34; B60T 8/38; B60T 8/40

(52) U.S. Cl. CPC B60T 8/344; B60T 8/38; B60T 8/4018; B60T 2220/04; B60T 2250/03; B60T 2270/82

(57) ABSTRACT

A method for controlling a hydraulic braking system for a vehicle with brake actuators for displacing brake pads relative to associated brake discs has the following steps: detecting lateral acceleration of the vehicle, and then, if no braking request is detected and if the lateral acceleration exceeds a defined threshold value, fixing the position of the brake pads by shutting off a hydraulic line leading to and/or away from the brake actuator. Furthermore, a hydraulic braking system for a vehicle with a control unit is provided which is designed to perform such a method.

### TECHNICAL FIELD

The invention relates to a method for controlling a hydraulic braking system for a vehicle with wheels and brake actuators associated with the wheels for displacing brake pads relative to associated brake discs. Furthermore, the invention relates to a hydraulic braking system with a control unit which is designed to perform such a method.

### BACKGROUND

Such hydraulic braking systems for vehicles as well as methods for controlling them are known.

In the automotive industry, efforts are constantly being made to improve braking systems and their control methods in order to increase safety even further.

Each vehicle, including the braking system, is subjected to different accelerations while driving. Particularly in the case of lateral acceleration, forces act which displace the brake pads and brake actuators associated with them. The brake fluid is here forced out of the corresponding hydraulic line into a connected fluid reservoir. In order to be able to apply a braking force to the wheel, the brake pad must be moved back to the brake disc when the brake is subsequently actuated, wherein the offset caused by the lateral acceleration must first be bridged again. Consequently, the application of the braking force is delayed. Moreover, the volume of fluid or the actuating travel of the brake actuator required to apply a certain braking force does not correspond to the usual amount and must be compensated accordingly.

A method for operating a braking system is known from DE 10 2008 034 769 A1. If high lateral acceleration occurs during cornering and the play between the brake pads and the brake disc becomes too great, the brake pads are actively applied to the brake disc by means of a brake activation, even if the brake pedal is not actuated. In this way, it is intended that the usual and familiar pedal feel for the braking process following the active application of the brake pads is reproduced for the driver.

The disadvantage of the method known from DE 10 2008 034 769 A1 is, inter alia, that, along with the active application of the brake pads, not only are the brake pads moved towards the brake disc again, but also a braking effect which can be perceived by the driver or even a braking procedure can be triggered.

### SUMMARY

The object of the invention is to provide a method for controlling a hydraulic braking system for a vehicle with increased safety. The object of the invention is further to provide a hydraulic braking system with a control unit which is designed to perform such a method.

The object is achieved by a method for controlling a hydraulic braking system for a vehicle with wheels and brake actuators, associated with the wheels, for displacing brake pads relative to associated brake discs, with the steps:
a) detecting lateral acceleration of the vehicle, and,
b) if no braking request is detected and if the lateral acceleration exceeds a defined threshold value, fixing the position of the brake pads by shutting off a hydraulic line leading to and/or away from the brake actuator.

With the method according to the invention, it can advantageously be effectively prevented that the brake pads and the associated brake actuators are displaced in the case of correspondingly high acting lateral forces, in particular away from the brake pads. Thus, the brake pads are held at a defined distance near the brake pads and can be actuated in a correspondingly short period of time and with a defined fluid volume or actuating travel. As a result, the time required to apply a defined braking force to the wheels is reduced, which in turn increases the safety of the vehicle.

The method according to the invention is, in particular compared with the method known from DE 10 2008 034 769 A1, effective because displacement of the brake pads and the associated brake actuators in the case of correspondingly high acting lateral forces is prevented proactively, i.e. in a predictive manner, such that active brake activation is not required in order to reapply the brake pads. This method is particularly effective in the case of vehicles with high engine power which are subjected to correspondingly high lateral acceleration when driving in a sporty manner.

It can be provided that the detection of the lateral acceleration is carried out via at least one sensor.

Thus, a value which is representative of the lateral acceleration or specifies it can be determined by means of the at least one sensor.

Within the meaning of the invention, the determined value can be a measured value or a value calculated from a measured value.

According to one aspect, the at least one sensor is a yaw rate sensor, by means of which the lateral acceleration can be reliably determined.

Depending on the operating state or design of the braking system, the hydraulic lines leading to the brake actuators and/or away from the brake actuators can be shut off anyway. This is usually not the case, however, if no braking request is detected because in this operating state of the braking system, the brake actuators are connected to the atmosphere via a fluid reservoir, inter alia for safety reasons.

In one embodiment, a connection between the brake actuator and a fluid reservoir is interrupted in order to shut off the hydraulic line leading away from the brake actuator. The path of the hydraulic line leading away from the brake actuator is consequently effectively shut off and fixes the brake pads.

The connection between the brake actuator and the fluid reservoir can here be interrupted by a valve being closed. This design is particularly simple and effective, for example when the valve is a two/two-way valve, in particular a known ABS drain valve.

In an additional or alternative embodiment, a further connection between the brake actuator and the fluid reservoir is interrupted in order to shut off the hydraulic line leading to the brake actuator. As a result, the path of the hydraulic line leading to the brake actuator is effectively shut off and fixes the brake pads.

The further connection between the brake actuator and the fluid reservoir can here be interrupted by a further valve being closed. This design is particularly simple and effective, for example when the further valve is a two/two-way valve, in particular a known ABS shut-off valve.

The further valve can also be a brake circuit valve assembly associated with the hydraulic line. In order to interrupt the further connection between the brake actuator and the fluid reservoir, the brake circuit valve assembly associated with the hydraulic line is transferred into a switching position in which the brake circuit associated with the brake actuator is shut off.

This design is also particularly simple and effective, for example, when the brake circuit valve assembly is not only designed to switch between a purely mechanical emergency mode of the braking system or an electrohydraulic normal mode of the braking system, but also has a switching position in order to shut off the brake circuit associated with the brake actuator. This is particularly possible if the brake circuit valve assembly comprises a combination of two two/two-way valves, whereby up to four switching positions are possible.

The further valve can also be a check valve. In order to interrupt the further connection between the brake actuator and the fluid reservoir, the check valve associated with the hydraulic line is held in a locked position.

Because, depending on the function, the check valve assumes a throughflow position depending on a certain pressure or a certain pressure difference, it can be provided that a pressure is generated by means of an electrohydraulic pressure-generating unit in the brake circuit associated with the brake actuator, which pressure holds the check valve in the locked position.

Preferably, the check valve is a spring-loaded check valve. Here, the pressure generated by means of the electrohydraulic pressure-generating unit can be adjusted or controlled depending on the spring loading of the check valve such that the check valve is held securely in the locked position.

Furthermore, as an additional or alternative measure for shutting off the hydraulic line leading to the brake actuator, a piston of an electrohydraulic pressure-generating unit can be displaced into a position in which the piston closes an inlet opening to a supply line, via which the electrohydraulic pressure-generating unit is fluidically connected directly to the fluid reservoir. Thus, no brake fluid can flow from the fluid reservoir via the supply line and through the electrohydraulic pressure-generating unit to the brake actuator.

For example, the fact that the electrohydraulic pressure-generating unit is fluidically connected via the supply line directly to the fluid reservoir means that no valve or no shut-off valve is arranged in the supply line between the inlet opening and the fluid reservoir.

In another embodiment, after the hydraulic line has been shut off, the hydraulic line is freed again as soon as the determined value drops below a defined further threshold value. In this way, it is ensured that the hydraulic line is only shut off for the period during which particularly high lateral forces act which can significantly displace the brake pads and the associated brake actuators.

According to one aspect, the further threshold value for freeing the hydraulic line can be the same as the threshold value for shutting it off.

It can moreover be provided that each brake actuator is connected in driving fashion to the pressure-generating unit via a separate hydraulic line and the brake actuators are shut off independently of each other. The brake actuators are here each shut off when a determined value associated with the brake actuator exceeds a defined threshold value. The hydraulic lines of the brake actuators can thus each be shut off and unblocked individually.

The braking system can be a brake-by-wire braking system.

According to the invention, in order to achieve the abovementioned object, a hydraulic braking system for a vehicle with wheels and brake actuators associated with the wheels, with hydraulic lines which run to and away from the associated brake actuators in driving fashion, and a control unit, is provided which is designed to perform a method according to the invention with the abovementioned advantages.

The braking system can here be a brake-by-wire braking system.

### BRIEF DESCRIPTION OF THE DRAWINGS

Further advantages and features can be found in the following description and in the attached drawings, in which:

FIG. 1 shows a schematic illustration of a first exemplary embodiment of a hydraulic braking system according to the invention,

FIG. 2 shows a schematic illustration of a second exemplary embodiment of a hydraulic braking system according to the invention,

FIG. 3 shows a schematic illustration of a third exemplary embodiment of a hydraulic braking system according to the invention, and

FIG. 4 shows a schematic illustration of an exemplary embodiment for the design of brake circuit valve assemblies.

### DESCRIPTION

The following detailed description in conjunction with the accompanying drawings, in which the same numbers refer to the same elements, is intended to describe different embodiments of the disclosed subject-matter and is not intended to represent the only embodiments. Each embodiment described in this disclosure is only an example or for illustrative purposes and should not be interpreted as preferred or advantageous compared with other embodiments.

All the features disclosed below with reference to the exemplary embodiment and/or the accompanying Figures can be combined on their own or in any subcombination with features of the aspects of the present disclosure, including features of preferred embodiments, provided that the resulting combination of features is meaningful to a person skilled in the art.

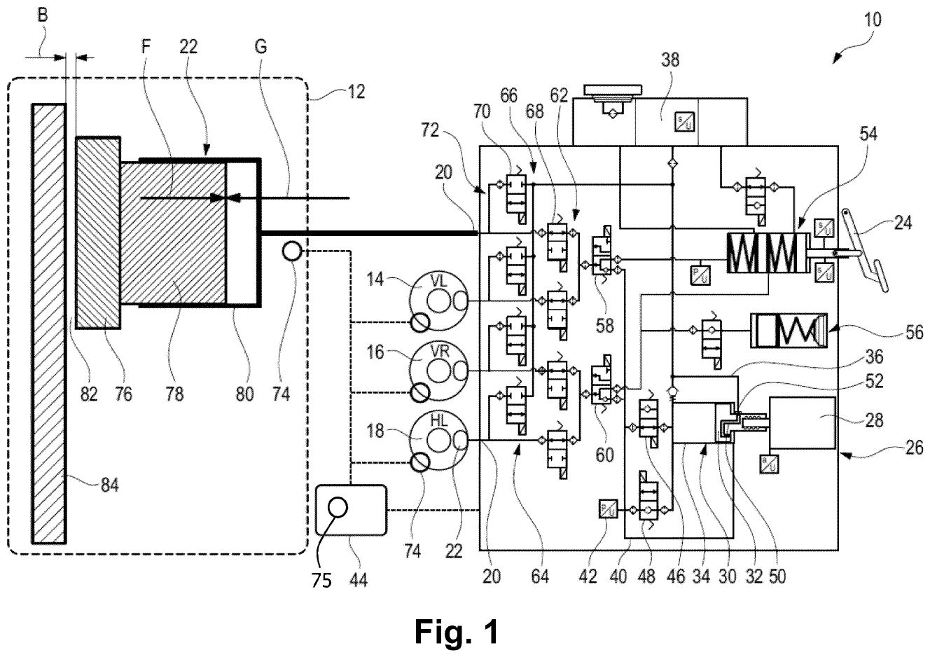

FIG. 1 shows a first exemplary embodiment of a hydraulic braking system 10 for a vehicle.

For reasons of clarity, not all identical components are provided with reference signs.

The braking system 10 is here designed for a vehicle with four wheels 12, 14, 16, 18 (rear right, front left, front right and rear left). All four wheels 12, 14, 16, 18 can be braked by means of the braking system 10.

For this purpose, the braking system 10 has a total of four pressure ports 20 for in each case one brake actuator 22. Each brake actuator 22 can be selectively pressurized and/or depressurized by means of the braking system 10 via a hydraulic line 72.

To actuate the braking system 10, the vehicle has a brake pedal 24 via which the driver can specify a braking request which corresponds to a certain braking force and thus a deceleration of the vehicle.

In this example, the braking system 10 is designed for a brake-by-wire method. The braking request is therefore transmitted electronically from the brake pedal 24 in a known manner to an electrohydraulic pressure-generating unit 26 of the braking system 10.

The electrohydraulic pressure-generating unit 26 essentially comprises essentially an electric drive motor 28 which is coupled in driving fashion to a piston/cylinder unit 30 with a linearly movable piston 32.

The piston 32 is guided in a cylinder 34 which, on the one hand, can be supplied via a supply line 36 with pressure fluid from a fluid reservoir 38 and, on the other hand, can feed pressure fluid under pressure into a main line 40.

Arranged in the main line 40 is a pressure sensor 42 which detects a hydraulic pressure provided by the electrohydraulic pressure-generating unit 26.

The pressure sensor 42 and the drive motor 28 of the electrohydraulic pressure-generating unit 26 are connected to a control unit 44 which receives sensor data from the pressure sensor 42 and can control the drive motor 28.

Optionally, further pressure sensors can be arranged at the individual brake actuators 22.

In the embodiment illustrated, the electrohydraulic pressure-generating unit 26 acts via a first supply valve 46 and a second supply valve 48 on the main line 40. In addition, the piston 32 is designed with an internal fluid channel 50. This design makes it possible in a known manner for the piston 32 to feed pressure fluid under pressure into the main line 40 both in the case of a stroke in a direction pointing away from the drive motor 28, and in the case of a stroke in a direction pointing towards the drive motor 28. Such pistons are also referred to as dual acting plungers.

In the present embodiment, the supply line 36 opens into the cylinder 34 via an inlet opening 52.

The cylinder 34 is here fluidically connected directly to the fluid reservoir 38 via the supply line 36.

In this context, the piston/cylinder unit 30 has a position in which the piston 32 blocks or closes the inlet opening 52 in such a way that substantially no pressure fluid can flow into the cylinder 34 via the inlet opening 52. In other words, in this position of the piston 32, the connection between the cylinder 34 and the supply line 36 via the inlet opening 52 is interrupted.

The piston/cylinder unit 30 is moreover designed to receive pressure fluid from the main line 40.

The control unit 44 is designed and programmed to predetermine a desired hydraulic pressure, also in a predetermined chronological sequence, in the main line 40 and to control the drive motor 28 accordingly.

The brake pedal 24 is moreover mechanically coupled to a master cylinder unit 54 for a purely mechanical emergency mode (so-called “push-through” mode).

The master cylinder unit 54 comprises in a known manner a fluid brake master cylinder which is equipped with a first piston and here a second piston. The master cylinder unit 54 is fluidically connected to the fluid reservoir 38.

The master cylinder unit 54 is used in electrohydraulic normal mode (so-called “brake-by-wire” mode) to generate the braking request. For this purpose, it can be coupled to a simulator unit 56 in a known manner.

The main line 40 leads to two brake circuit valve assemblies 58, 60 which define a first brake circuit 62 and a second brake circuit 64. By switching the brake circuit valve assemblies 58, 60, the two brake circuits 62, 64 are fluidically decoupled and can be connected either for a brake-by-wire mode to the main line 40, or for a push-through mode to the master cylinder unit 54.

The brake circuit valve assemblies 58, 60 are, as illustrated in FIG. 1, each configured as three/two-way valves, in the unactuated state of which the brake circuits 62, 64 are connected to the master cylinder unit 54, and in the actuated state of which the brake circuits 62, 64 are connected (only) to the main line 40.

Optionally, the brake circuit valve assemblies 58, 60 can each be configured as three/three-way valves to provide a further (third) switching position in which, for example, the brake circuits 62, 64 are shut off from both the main line 40 and from the master cylinder unit 54.

If more than two switching positions are to be provided, the brake circuit valve assemblies 58, 60 can each optionally be configured as two two/two-way valves (arranged in parallel), whereby even up to four switching positions are possible.

The first brake circuit 62 here comprises the pressure ports 20 for the wheels 12, 14, i.e. rear right and front left. The second brake circuit 64 accordingly comprises the pressure ports 20 for the wheels 16, 18, i.e. front right and rear left. In brake-by-wire mode, both brake circuits 62, 64 are pressurized. However, it is possible to operate the braking system 10 with only one brake circuit 62, 64 and still brake the vehicle safely.

Fluidically connected to the two brake circuit valve assemblies 58, 60 in the direction of the pressure ports 20 in each brake circuit 62, 64 is a pressure modulation unit 66 which, together with the control unit 44 and the brake actuators 22, in a known manner provides, inter alia, the functionality of an anti-lock braking and/or vehicle dynamics control system. Associated with each pressure port 20 here is a first valve 68 which is formed here by a known ABS shut-off valve, and a second valve 70 which is formed here by a known ABS discharge valve.

Usually, as illustrated in FIG. 1, the first valve 68 designed as a shut-off valve is configured as a so-called “normally opened” two/two-way valve which assumes its throughflow position in the unactuated state, and the second valve 70 designed as a discharge valve is configured as a so-called “normally closed” two/two-way valve which assumes its shut-off position in the unactuated state.

Such valve switching is known per se and is therefore not explained in more detail.

In this context, the brake actuators 22 are in each case connected to the hydraulic braking system 10 via a hydraulic line 72 and run in driving fashion to and away from the corresponding brake actuator 22.

The first valve 68 and/or the second valve 70, which are associated with a brake actuator 22, can each be part of the corresponding hydraulic line 72, wherein the first valve 68 is arranged in a path of the hydraulic line 72 which leads to the brake actuator 22, and the second valve 70 is arranged in a path of the hydraulic line 72 which leads away from the brake actuator 22.

The control unit 44 is moreover connected by signals to four sensors 74 which are each associated with one of the four wheels 12, 14, 16, 18.

The sensors 74 are designed to determine wheel speeds of the associated wheels 12, 14, 16, 18, and are, for example, wheel speed sensors such that, depending on speed differences between wheels of a vehicle axle, a lateral acceleration of the vehicle can be calculated.

In principle, the hydraulic braking system 10 can have any number of sensors 74 to determine the lateral acceleration of the vehicle.

For example, the hydraulic braking system 10 according to one variant has front sensors 74 which determine the lateral acceleration of the vehicle for the front wheels 14, 16, and/or rear sensors 74 which determine the lateral acceleration of the vehicle for the rear wheels 12, 18.

In a preferred manner, the hydraulic braking system 10 according to a further variant has, in addition to the sensors 74, a further sensor 75 which is, for example, a yaw rate sensor and determines the lateral acceleration of the vehicle.

The sensor 75 is here integrated within the control unit 44. Optionally, the sensor 75 can be arranged outside the control unit, for example near the centre of gravity of the vehicle.

If the vehicle is subjected to lateral acceleration, forces also act correspondingly on the brake actuators 22 and the brake pads 76 associated with them.

In the case of high lateral acceleration, correspondingly high forces are exerted, as a result of which the brake pad 76 is normally displaced together with the brake piston 78 bearing against the brake pad 76 relative to the brake cylinder 80 of the brake actuator 22, and the width B of the air gap 82 between the brake pad 76 and the associated brake disc 84 of the brake of the vehicle changes. If, for example, as illustrated in FIG. 1, a force F is exerted to the right by the lateral acceleration, the width B of the air gap 82 increases accordingly.

To prevent this, the control unit 44 is designed and programmed to perform the following method.

In this method, when no braking request is detected and when a determined value of the lateral acceleration exceeds a defined threshold value, the path of the hydraulic line 72 leading away from the corresponding brake actuator 22 is shut off by the second valve 70 of the corresponding hydraulic line 72 being closed.

In this way, the brake actuator 22 is fluidically separated from the fluid reservoir 38 such that the pressure fluid in the hydraulic line 72 cannot drain into the fluid reservoir 38. For this purpose, the second valve 70, if configured as a normally closed valve, can remain in its unactuated shut-off position; otherwise, the second valve 70 would be switched from its unactuated throughflow position to its shut-off position.

Moreover, the path of the hydraulic line 72 leading to the corresponding brake actuator 22 is shut off in order to fluidically separate the brake actuator 22 from the fluid reservoir 38 such that the pressure fluid in the hydraulic line 72 cannot flow out into the fluid reservoir 38. To do this:
as a first measure M1, the first valve 68 of the corresponding hydraulic line 72 can be closed by switching the first valve 68, if it is configured as a normally opened valve, from its unactuated throughflow position to its shut-off position; otherwise, the first valve 68 may remain in its unactuated shut-off position.
as a second measure M2, the brake circuit valve assembly 58, 60 associated with the corresponding hydraulic line 72 can be transferred into a switching position in which the corresponding brake circuit 62, 64 is shut off from both the main line 40 and from the master cylinder unit 54.
as a third measure M3, the piston 32 of the piston/cylinder unit 30 can be displaced into a position in which the piston 32 blocks the inlet opening 52 such that there is no connection to the fluid reservoir 38 via the supply line 36.

The measures M1 to M3 can be carried out as an alternative or as alternatives in each case individually or as a combination or combinations. Owing to the measures M1 to M3, the brake actuator 22 is separated fluidically from the fluid reservoir 38 such that the pressure fluid in the hydraulic line 72 cannot flow out into the fluid reservoir 38.

As a result, the pressure fluid enclosed in the hydraulic line 72 generates a counterforce G, which compensates the force F with which the brake pad 76 and the brake piston 78 are pressed in the axial direction into the brake cylinder 80.

Consequently, the width B of the air gap 82 remains constant and thus the brake pad 76 is arranged in a defined manner relative to the brake disc 84.

As soon as a braking request is detected or as soon as the determined lateral acceleration value drops below a defined further threshold value, the hydraulic line 72 is freed again.

In principle, the shutting-off of the hydraulic lines 72 can be carried out jointly for all the brake actuators 22, in groups for one or more brake actuators 22, or for each brake actuator 22 individually.

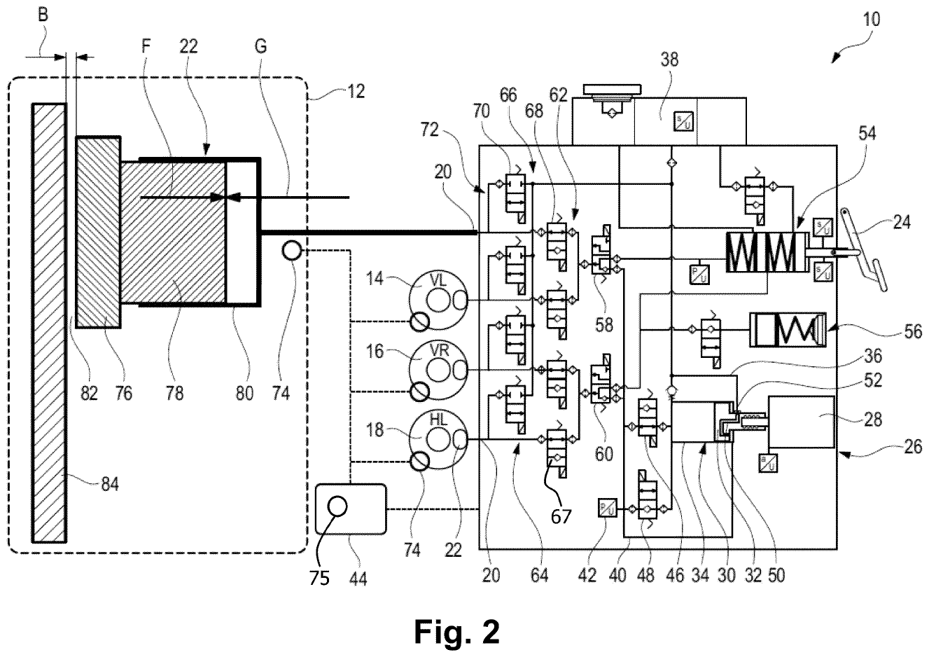

FIG. 2 shows a second exemplary embodiment of a hydraulic braking system 10 for a vehicle.

In contrast to the exemplary embodiment shown in FIG. 1, the first valve 68, configured as a “normally opened” two/two-way valve, here comprises a check valve/shut-off valve function which is constituted as a check valve 67.

As illustrated here, the check valve 67 is integrated into the (actuated) shut-off position of the first valve 68. Optionally, the check valve 67 can be arranged as a separate valve parallel to the first valve.

The throughflow direction of the check valve function is designed such that the path of the hydraulic line 72 leading to the corresponding brake actuator 22 is shut off and the path of the hydraulic line 72 leading away from the brake actuator 22 is opened.

The check valve 67 can be a spring-loaded check valve, wherein the check valve function can be adapted to a differential pressure present between the brake actuator 22 and the corresponding brake circuit 62, 64 by means of a spring element which is not illustrated in detail.

The differential pressure at which the check valve 67 switches from its shut-off position to its throughflow position can be predetermined, for example, by dimensioning the spring element which is not illustrated in detail. The spring element can here be dimensioned such that the differential pressure is sufficient to hold the check valve 67 in its shut-off position and thus hold the pressure fluid in the hydraulic line 72 in order to generate a counterforce G for compensating the force F.

In the case of a high counterforce G, which can occur in the case of high lateral acceleration, the pressure in the corresponding brake circuit 62, 64 can be increased by means of the piston/cylinder unit 30, as a result of which the differential pressure is reduced such that the check valve 67 is held in its shut-off position.

Thus, the exemplary embodiment shown in FIG. 2 discloses, in addition to or as an alternative to the exemplary embodiment shown in conjunction with FIG. 1, further measures to prevent that pressure fluid in the hydraulic line 72 from not being able to flow out into the fluid reservoir 38, namely:
as a fourth measure M4, that the first valve 68 comprises a check valve function, as a result of which the first valve 68 remains in its shut-off position as a function of a predeterminable pressure difference.
as a fifth measure M5, that the pressure in the corresponding brake circuit 62, 64 is increased by means of the piston/cylinder unit 30 in order to hold the first valve 68 in its shut-off position.

Overall, all of the measures M1 to M5 can be carried out as an alternative or as alternatives in each case individually or as a combination or combinations among themselves.

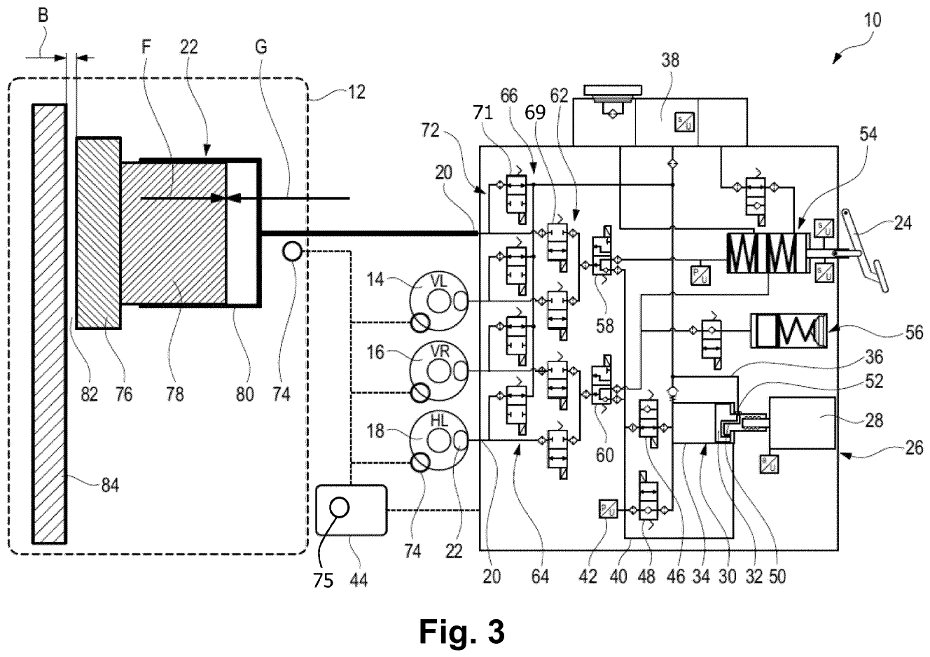

FIG. 3 shows a third exemplary embodiment of a hydraulic braking system 10 for a vehicle.

In contrast to the exemplary embodiment shown in FIG. 1 or FIG. 2, the first valve is here configured as a “normally closed” two/two-way valve 69 and the second valve as a “normally opened” two/two-way valve 71.

Owing to this configuration, the first valve 69 in the unactuated state (always) assumes its shut-off position, as a result of which the path of the hydraulic line 72 leading to the corresponding brake actuator 22 is shut off. Consequently, the second valve 71 is (only) to be switched from its unactuated throughflow position to its shut-off position in order to also shut off the path of the hydraulic line 72 leading away from the corresponding brake actuator 22.

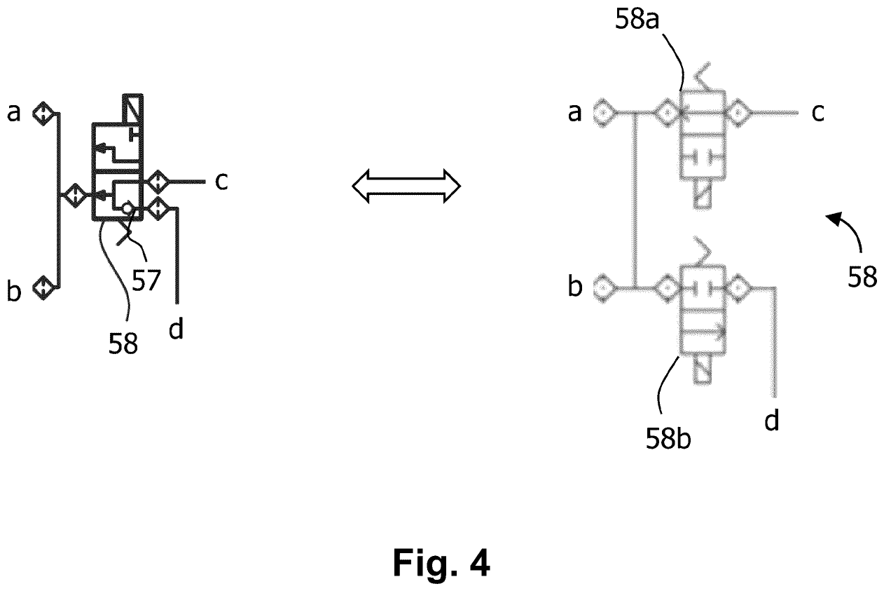

FIG. 4 shows a further exemplary embodiment for the configuration of the brake circuit valve assemblies 58, 60, on the example of a brake circuit valve assembly 58.

As already explained with reference to FIG. 1, the brake circuit valve assemblies 58, 60 can in each case be configured as two two/two-way valves (switched in parallel) instead of a three/two-way valve such that up to four switching positions are possible.

For this purpose, as illustrated in FIG. 4, a three/two-way valve 58, which is illustrated in FIGS. 1 to 3, is replaced between the (four) connection points a to d by a first two/two-way valve 58a and a second two/two-way valve 58b.

Here, the first two/two-way valve 58a is configured as a so-called “normally opened” valve which assumes its throughflow position in the unactuated state, and the second two/two-way valve 58b is configured as a so-called “normally closed” valve which assumes its shut-off position in the unactuated state.

As a result, for a push-through mode, the connection of connection point c (master cylinder unit 54) to the connection points a, b (brake circuit 62 or brake actuators 22) is opened, and the connection of connection point d (main line 40 or piston/cylinder unit 30) to the connection points a, b is closed.

The path of the hydraulic line 72 leading from the fluid reservoir 42 to a brake actuator 22 can here be opened via the master brake cylinder unit 54. In order to shut off this path—within the meaning of the second measure M2 already explained with reference to FIG. 1—the first two/two-way valve 58a must be switched to its actuated shut-off position.

For brake-by-wire mode, both two/two-way valves 58a, 58b are actuated here in order to close the connection from connection point c (master cylinder unit 54) to the connection points a, b (brake circuit 62 or brake actuators 22), and to open the connection from connection point d (main line 40 or piston/cylinder unit 30) to the connection points a, b (brake actuators 22).

The path of the hydraulic line 72 leading from the fluid reservoir 42 to a brake actuator 22 can be opened via the main line 40 or the piston/cylinder unit 30. In order to shut off this path—within the meaning of the second measure M2 already explained with reference to FIG. 1—the second two/two-way valve 58b must be switched to its actuated shut-off position.

Furthermore, FIG. 4 shows that the brake circuit valve assembly 58 can comprise a check valve/shut-off valve function which is constituted as a further check valve 57 and is integrated here into the (unactuated) starting position of the three/two-way valve 58. Optionally, the check valve 57 can be arranged as a separate valve parallel to the three/two-way valve.

The throughflow direction of the check valve function is designed here such that the path of the hydraulic line 72 leading to the corresponding brake actuator 22—i.e. the connection from the connection point d (main line 40 or piston/cylinder unit 30) to the connection points a, b (brake actuators 22)—is opened, and the path of the hydraulic line 72 leading away from the brake actuator 22—i.e. the connection from the connection points a, b (brake actuators 22) leading away to the connection point d (main line 40 or piston/cylinder unit 30)—is closed.

The check valve 57 can be a spring-loaded check valve, wherein the check valve function can be adapted to a differential pressure present between the piston/cylinder unit 30 and the corresponding brake circuit 62, 64, or brake actuator 22, by means of a spring element not illustrated in detail.

1. Method for controlling a hydraulic braking system for a vehicle with wheels and brake actuators associated with the wheels for displacing brake pads relative to associated brake discs, with the following steps:
a) detecting lateral acceleration of the vehicle, and,
b) if no braking request is detected and if the lateral acceleration exceeds a defined threshold value, fixing the position of the brake pads by shutting off a hydraulic line leading to and/or away from the brake actuator.

2. Method according to claim 1, wherein the detection of the lateral acceleration is carried out via a sensor.

3. Method according to claim 2, wherein a value which is representative of the lateral acceleration or specifies it is determined by means of the sensor.

4. Method according to claim 2, wherein the sensor is a yaw rate sensor.

5. Method according to claim 1, wherein a connection between the brake actuator and a fluid reservoir is interrupted in order to shut off the hydraulic line leading away from the brake actuator.

6. Method according to claim 5, wherein the connection between the brake actuator and the fluid reservoir is interrupted by a valve being closed.

7. Method according to claim 5, wherein a further connection between the brake actuator and the fluid reservoir is interrupted in order to shut off the hydraulic line leading to the brake actuator.

8. Method according to claim 7, wherein the further connection between the brake actuator and the fluid reservoir is interrupted by a further valve being closed.

9. Method according to claim 8, wherein a brake circuit valve assembly associated with the hydraulic line is transferred into a switching position in which the brake circuit associated with the brake actuator is shut off.

10. Method according to claim 8, wherein a check valve associated with the hydraulic line is held in a shut-off position.

11. Method according to claim 10, wherein a pressure is generated by means of an electrohydraulic pressure-generating unit in the brake circuit associated with the brake actuator, which pressure holds the check valve in the shut-off position.

12. Method according to claim 10, wherein the check valve is a spring-loaded check valve.

13. Method according to claim 7, wherein, in order to shut off the hydraulic line leading to the brake actuator, a piston of an electrohydraulic pressure-generating unit is displaced into a position in which the piston closes an inlet opening to a supply line, via which the electrohydraulic pressure-generating unit is fluidically connected directly to the fluid reservoir.

14. Method according to claim 1, wherein, after the hydraulic line has been shut off, the hydraulic line is freed again as soon as the determined value drops below a defined further threshold value.

15. Method according to claim 1, wherein each brake actuator is connected in driving fashion to the pressure-generating unit via a separate hydraulic line and the brake actuators are shut off independently of each other, wherein the brake actuators are shut off in each case when a determined value associated with the brake actuator exceeds a defined threshold value.

16. Method according to claim 1, wherein the braking system is a brake-by-wire braking system.

17. Hydraulic braking system for a vehicle with wheels and brake actuators associated with the wheels with hydraulic lines which run to and away from the associated brake actuators in driving fashion, and a control unit which is designed to perform a method according to claim 1.

18. Braking system according to claim 17, wherein the braking system is a brake-by-wire braking system.
